(19) United States
(12) Patent Application Publication
(10) Pub. No.: US 2009/0136413 A1
(43) Pub. Date: May 28, 2009

(54) Method for enhanced synthesis of carbon nanostructures

(76) Inventors: Zhongrui Li, Little Rock, AR (US); Yang Xu, Little Rock, AR (US); Alexandru S. Biris, Little Rock, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 12/286,571

(22) Filed: Oct. 1, 2008

Related U.S. Application Data
(60) Provisional application No. 61/003,206, filed on Nov. 15, 2007.

(51) Int. Cl. D01F 9/127; B82B 3/00

(52) U.S. Cl. 423/447.3; 977/742; 977/843

(57) ABSTRACT

A method of significantly improving carbon nanotube or carbon nanofiber yield from catalytic chemical vapor deposition of a carbon-containing gas comprising at least one hydrocarbon with the assistance of a proper amount of carbon dioxide (CO₂). The catalytic particles preferably contain at least one metal from Group VIII (Fe, Co, Ni or the like) or/and one metal from Group VIb, including Mo, W, and Cr. The catalytic particles are preferably supported on oxide powders such as MgO, Al₂O₃, SiO, CaO, TiO, and ZrO, or a flat substrate such as, but not limited to, a Si wafer. The carbon nanotube or nanofiber product is preferably formed by exposing the catalyst to a mixture of a carbon-containing gas comprising at least one hydrocarbon with a proper amount of CO₂ at a sufficiently high temperature. In an alternative embodiment, other oxygen-containing gases, such as alcohols, may be included in the mixture in addition to carbon dioxide.

### CROSS-REFERENCE TO RELATED APPLICATIONS

This application claims the benefit of U.S. Provisional Patent Application No. 61/003,206 filed Nov. 15, 2007, the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

This invention is related to the field of catalysis for producing carbon nanostructures, including carbon nanotubes and nanofibers.

Carbon nanotubes (CNTs) are seamless tubes of graphite sheets with full fullerene caps which were first discovered as multi-layer concentric tubes or multi-walled carbon nanotubes (MWNTs) and subsequently as single-walled carbon nanotubes (SWNTs) formed in the presence of transition metal catalysts. Carbon nanotubes have shown promising applications including nanoscale electronic devices, high strength materials, electron field emission, tips for scanning probe microscopy, solar cell, and gas storage.

However, the availability of CNTs and carbon nanofibers in quantities and forms necessary for practical applications is still problematic. Large scale processes for the production of high quality CNTs and nanofibers are still needed, and suitable forms of the CNTs and nanofibers for application to various technologies are still needed.

### BRIEF SUMMARY OF THE INVENTION

The present invention is directed to a method that satisfies this need. The method of the present invention significantly improves carbon nanotube and nanofiber yield from catalytic chemical vapor deposition of hydrocarbon with the assistance of carbon dioxide. The catalytic particles preferably contain at least one metal from Group VIII (Fe, Co, Ni or the like) or/and one metal from Group VIb, including Mo, W, and Cr. The catalytic particles are preferably supported on oxide powders such as MgO, Al₂O₃, SiO, CaO, TiO, and ZrO, or a flat substrate such as, but not limited to, a Si wafer. The carbon nanotube or nanofiber product is preferably formed by exposing the catalyst to a mixture of a carbon-containing gas comprising at least one hydrocarbon (for example, CxHy) with a proper amount of carbon dioxide (CO₂) at a sufficiently high temperature. In an alternative embodiment, the mixture may also include other oxygen-containing gases, such as alcohols.

These and other features, objects and advantages of the present invention will become better understood from a consideration of the following detailed description of the preferred embodiments and appended claim in conjunction with the drawings as described following:

### BRIEF DESCRIPTION OF THE SEVERAL VIEWS OF THE DRAWINGS

FIG. 1 is a schematic diagram depicting both the resistive external furnace (EF) heating and inductive (RF) heating processes. The image to the right shows the glowing susceptor inside the RF induction coil during the synthesis of carbon nanotubes.

FIG. 2 is a graph showing the SWNT yield as a function of CO₂/CH₄ ratio.

FIG. 3 is a graph showing the Thermo Gravimetrical Analysis (TGA) of SWNT products produced with and without CO₂. The solid line is for a CO₂ to CH₄ ratio of 0 while the dotted line is for a CO₂ to CH₄ ratio of 1/20. The SWNTs synthesized with proper CO₂ to CH₄ ratio in the carbon source have better crystallinity than that produced without CO₂ assistance, as indicated by the higher combustion temperature.

FIG. 4 is a graph of the Raman spectra of CNTs grown with (the dotted line) and without (the solid line) CO₂ assistance.

FIG. 5 is a TEM image of the resulting CNT produced with CO₂.

FIG. 6 is a graph of the MWNT yield as a function of CO₂/C₂H₂ ratio.

FIG. 7 is a graph of the MWNT yield obtained from FeₓCO₅₋ₓ/CaCO₃ (Fe:Co:CaCO₃ weight ratio=x: 5-x: 95) catalysts.

FIG. 8 is a graph of the combustion temperature of MWNT as a function of Fe loading in the FexCo5-x/CaCO₃ (Fe:Co:CaCO₃ weight ratio=x: 5-x: 95) catalysts.

FIG. 9 is a graph of the Raman scattering spectra from the MWNTs grown with and without CO₂. The higher I_{G}/I_{D} and I_{G}/I_{G} values of the MWNTs grown with CO₂ indicate higher quality.

### DETAILED DESCRIPTION OF THE INVENTION

The present invention contemplates methods of increasing the yield of CNTs which are produced from catalytic chemical vapor deposition of hydrocarbon as carbon source on various catalysts system, such as magnesia powders which have small amounts of catalytic metal, e.g., iron and molybdenum, disposed thereon. Although the embodiments of the invention described herein with respect to carbon nanotubes, the method of the present invention may also be used in the production of carbon nanofibers. As used herein, the term “carbon nanostructures” shall be intended to refer to carbon nanotubes, whether single-walled, double-walled or multi-walled, to carbon nanofibers, or to a mixture of any of the preceding.

The carbon nanotubes produced herein can be used, for example as, electron field emitters, fillers of polymers in any product or material in which an electrically-conductive polymer film is useful or necessary for production. CNTs grown on catalysts can be removed from the catalysts by different means (including, but not limited to, burning away the amorphous carbon in air at low temperature (250-350° Celsius depending on the wall number of the CNTs), washing with acid or base solution depending on the properties of the catalyst supports, sonication, centrifugation, and chemical etching of the supports) resulting in high purity CNTs that can be used for any CNT application. The CNT material could also be used in applications such as sensors, interconnects, transistors, field emission devices, photovoltaic devices, and other devices.

The support material for the catalyst can be either powder or a flat substrate. Commonly used powders with large surface area may include (but are not limited to) MgO, Al₂O₃, SiO₂, CaO, TiO₂, and ZrO. Materials having flat surfaces contemplated for use as flat substrates or support material for the catalysts described herein, may include or may be constructed from: wafers and sheets of SiO₂, Si, organometalic silica, p- or n-doped Si wafers with or without a SiO₂ layer, Si₃N₄, Al₂O₃, MgO, quartz, glass, oxidized silicon surfaces, silicon carbide, ZnO, GaAs, GaP, GaN, Ge, InP, sheets of metal such as iron, steel, stainless steel, molybdenum and ceramics such as alumina, magnesia and titania.

The catalytic precursor solutions used for applying catalytic coatings to the supports of the present invention preferably comprise at least one metal from Group VIII, Group VIb, Group Vb, or rhenium (Re) or mixtures having at least two metals therefrom. Alternatively, the catalytic precursor solutions may comprise rhenium and at least one Group VIII metal such as Fe, Co, Ni, Ru, Rh, Pd, Ir, and/or Pt. The Re/Group VII catalyst may further comprise a Group VIb metal such as Cr, W, or Mo, and/or a Group Vb metal, such as Nb. Preferably the catalytic precursor solutions comprise a Group VII metal and a Group VIb metal, for example, Fe and Mo.

The ratio of the Group VII metal to the Group VIb metal and/or Re and/or Group Vb metal in the catalytic materials may affect the yield, and/or the selective production of SWNTs as noted elsewhere herein. The molar ratio of the Fe (or other Group VII metal) to the Group VIb or other metal is preferably from about 1:10 to about 10:1; still more preferably from 1:5 to about 5:1; and further including 1:9, 1:8, 1:7, 1:6, 1:5, 1:4, 1:3, 1:2, 1:1, 2:1, 3:1, 4:1, 5:1, 6:1, 7:1, 8:1, and 9:1, and ratios inclusive therein. Generally, the concentration of the Mo metal, where present, exceeds the concentration of the Group VII metal (e.g., Co) in catalytic precursor solutions and catalytic compositions employed for the selective production of CNTs.

The catalytic precursor solution is preferably deposited on a support material (substrate) such as a MgO powder as noted above or other flat materials known in the art and other supports as described herein. Preferably, the catalytic precursor solution is applied in the form of a liquid precursor (catalyst solution) over the substrate.

As noted elsewhere herein, the catalysts as described herein include a catalytic metal composition deposited upon a support material (either flat substrate or powder).

The catalytic materials used in the present invention are prepared in one embodiment by depositing different metal solutions of specific concentrations upon the powder support (e.g., MgO). For example, Fe/Mo catalysts can be prepared by impregnating various supports with aqueous solutions of iron nitrate and ammonium heptamolybdate (or molybdenum chloride) to obtain the bimetallic catalysts of the chosen compositions. The total metal loading is preferably from 0.01 to 10 wt % of the support. After deposition of the metal, the catalysts are preferably first dried in air at room temperature, then in an oven at 100° C.-150° C. for example, and finally calcined in flowing air at 450° C.-550° C.

Carbon nanotubes can be produced on these catalysts in different reactors known in the art such as packed bed reactors, structured catalytic reactors, or moving bed reactors (e.g., having the catalytic substrates carried on a conveying mechanism).

The catalysts may optionally be pre-reduced (e.g., by exposure to H₂ at 500° C. or, for example, at a temperature up to the reaction temperature) before the catalyst is exposed to reaction conditions. Prior to exposure to a hydrocarbon gas (e.g., CH₄), the catalyst is heated in an inert gas (e.g., He) up to the reaction temperature (600° C.-1050° C.). Subsequently, a hydrocarbon gas (e.g., CH₄) or gasified liquid (e.g., benzene) is introduced. After a given reaction period ranging preferably from 0.5 to 600 min, the catalyst having CNTs thereon is cooled down to a lower temperature such as room temperature.

For a continuous or semi-continuous system, the pretreatment of the catalyst may be done in a separate reactor, for example, for pretreatment of much larger amounts of catalyst whereby the catalyst can be stored for later use in the carbon nanotube production unit.

Where used herein, the phrase “an effective amount of a carbon-containing gas” means a gaseous carbon species (which may have been liquid before heating to the reaction temperature) present in sufficient amounts to result in deposition of carbon on the catalytic flat surfaces at elevated temperatures, such as those described herein, resulting in formation of CNTs thereon.

Examples of suitable carbon-containing gases (including gasified liquids) which may be used herein include aliphatic hydrocarbons, both saturated and unsaturated, such as methane, ethane, propane, butane, hexane, ethylene, and propylene; aromatic hydrocarbons such as toluene, benzene and naphthalene; and mixtures of the above, for example benzene and methane. The carbon-containing gas may optionally be mixed with a diluent gas such as helium, argon or hydrogen. The carbon-containing gas is mixed with an appropriate amount of carbon dioxide (CO₂). In an alternative embodiment, the mixture may also include other oxygen-containing gases, such as alcohols. Such alcohols may include, for example, ethanol.

The ratio of CO₂ to the hydrocarbon in the carbon sources may affect the yield, and/or the selective production of CNTs as noted elsewhere herein. The molar ratio of the CO₂ to the hydrocarbon is preferably from about 1:20 to about 1:1 depending on the type of hydrocarbon, for example, 1:10 for CH₄, and 1:2 C₂H₂. Generally, the concentration of the hydrocarbon, where present, exceeds the concentration of the CO₂ in carbon sources.

Carrier gas such as inert gas is preferably introduced in the gas feed in order to reduce the amorphous carbon byproduct. The molar ratio of the carbon source (the total amount in moles of CO₂ and hydrocarbon) to the inert gas is preferably from about 1:20 to about 1:2. Generally, the concentration of the inert gas, where present, exceeds the concentration of the carbon sources (hydrocarbon plus CO₂).

The preferred reaction temperature for use with the catalyst is between about 600° C. and 1100° C.; more preferably between about 650° C. and 1000° C.; and most preferably between 750° C. and 950° C.

In one embodiment, with optimized CO₂ amount, the total SWNT product can increase more than 50%, up to 200% in weight, as compared with the same synthesis process without CO₂ assistance. Furthermore, SWNTs may comprise 60%-150% of the total CNT product (compared with the catalyst weight).

In an alternate embodiment, with optimized CO₂ amount, the total MWNT product can increase more than 150%, up to 350% in weight, as compared with the same synthesis process without CO₂ assistance. Furthermore, MWNTs may comprise 160%-280% of the total CNT product (compared with the catalyst weight).

In an alternate embodiment, with optimized CO₂ amount, the total DWNT (double-walled carbon nanotube) product can increase more than 100%, up to 250% in weight, as compared with the same synthesis process without CO₂ assistance. Furthermore, MWNTs may comprise 90%-200% of the total CNT product (compared with the catalyst weight).

Besides the increase in the CNT yield, this invention also can reduce the amount of amorphous carbon in the byproduct, with optimal amount of CO₂ can also keep the catalyst active for a longer time, and accordingly improve the crystallinity of the CNTs, and elongate the length of the tubes.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention. Thus, the following examples, which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLE 1

### Growth and Harvest of SWNTs

Catalyst Preparation. Any catalyst known to those in the art can be used in the practice of the present invention. One such example is the following: A Fe—Mo/MgO catalyst was prepared by an impregnation method. An iron nitrate hydrate (Fe(NO₃)₃.9H₂O) and ammonium molybdate ((NH₄)₆Mo₇O₂₄.4H₂O) solution with MgO powder was ultrasonicated to a gel, dried at 383 K, ground to a fine powder, and then calcined at 823 K. The weight ratio of catalyst was 1:1:40 for Fe/Mo/MgO.

Synthesis of SWNTs. The synthesis of SWNTs at 1173 K performed with adding and not adding CO₂ were compared. Around 200 mg of the catalyst was uniformly spread into a thin layer under nitrogen flow at 200 ml/min on a graphite susceptor and placed at the center of a quartz tube positioned horizontally inside an inductive furnace. After purging the system with nitrogen as carrier gas for 10 minutes, radio frequency (RF) heating at 350 KHz was applied to the graphite susceptor that contains the catalyst. The catalyst was first reduced with hydrogen (20 ml/min) for 30 minutes at 720° C., and then followed by the introduction of methane at 50 ml/min for about 30 minutes. The concentration of CO₂ was controlled to 0.1-50% in the reactant gas (CH₄). The carbon feedstock was diluted by nitrogen in order to decrease the contact time between the carbon feedstock and the catalyst, and consequently reduce the formation of amorphous carbon. Neither nanotubes nor any other types of carbon byproducts were found in the experiments performed only with a graphite susceptor without a catalyst.

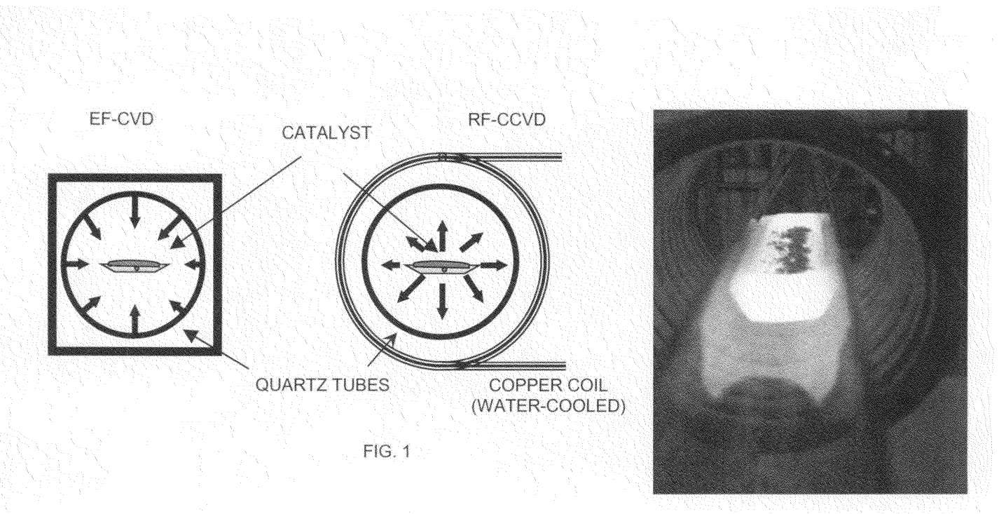

FIG. 1 is a schematic diagram depicting both the resistive external furnace (EF) heating and inductive (RF) heating processes. The image to the right shows the glowing susceptor inside the RF induction coil during the synthesis of multi-wall carbon nanotubes. Apparatus and methods for making nanostructures by induction heating are disclosed in U.S. Publ. Pat. Appl. Nos. 2005/0287297 and 2007/0068933, the disclosures of which are incorporated herein by reference.

The as-produced CNTs can be purified in two steps: 1) burn the as-produced CNTs in air at 300° C. for 6 hours; 2) then put it in a diluted hydrochloric acid solution (1:1 v/v) under bath sonication for 30 minutes, after that, wash it with water through membrane filtration; 3) perform the second wash with nitric acide (1:3 v/v) under bath sonication for 1 hour; 4) rinse it with distilled water through vacuum filtration and dry the final product at 120° C. overnight.

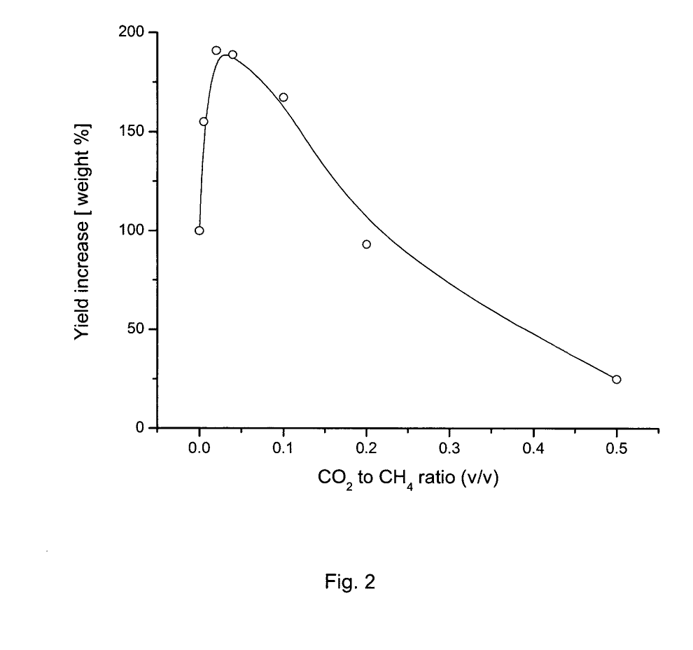

The SWNT yield from thermal decomposition of methane on Fe—Mo/MgO catalyst is shown in FIG. 2 as a function of the CO₂-to-CH₄ ratio. Addition of a small amount of CO₂ can significantly increase the CNT yield. The optimized yield of about 190% increase can be obtained at the CO₂-to-CH₄ ratio of 1:20.

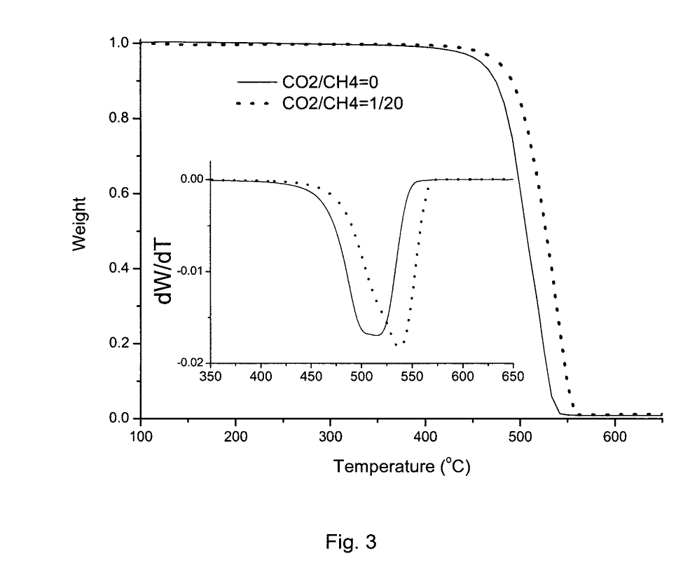

FIG. 3 shows the TGA of SWNT products produced with and without CO₂. The SWNTs synthesized with proper CO₂ to CH₄ ratio in the carbon source have better crystallinity than that produced without CO₂ assistance, as indicated by the higher combustion temperature.

Thermo Gravimetric Analysis (TGA) was used to study the thermal behavior of the catalyst system and to determine the overall purity of CNTs. Thermo Gravimetric Analysis was performed under air flow of 150 ml/min using a Meftler Toledo TGA/SDTA 851e.

Raman scattering spectra of the catalysts and CNTs were collected at room temperature on a Horiba Jobin Yvon LabRam HR800 equipped with a charge-coupled detector and a spectrometer with a 600 lines/mm grating. A He—Ne (633 nm) laser was used as the excitation source. The laser beam intensity measured at the sample was kept at 5 mW. A 50× confocal Olympus microscope focused the incident beam to the sample with a spot size less than 1 μm², and the backscattered light was collected backward from the direction of incidence. Raman shifts were calibrated with a silicon wafer at the peak of 521 cm⁻¹. The spectral resolution was 1 cm⁻¹ and the collected signal was averaged over 10 spots.

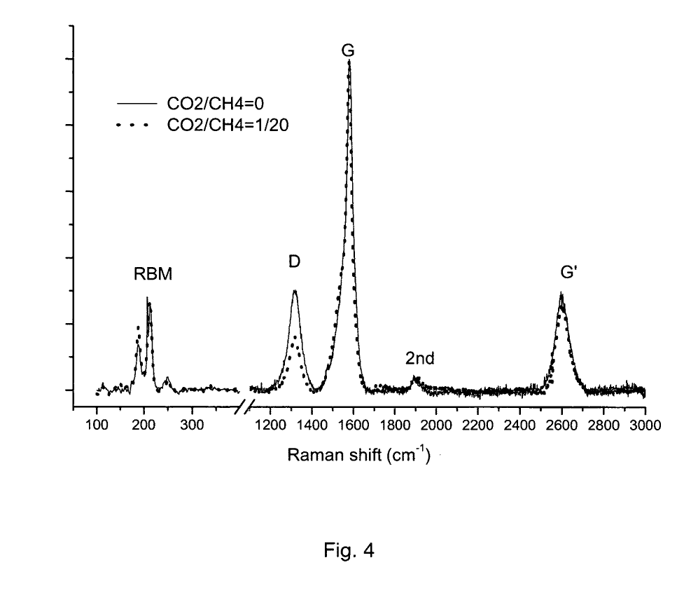

FIG. 4 shows the Raman spectra of CNTs grown with and without CO₂ assistance. The Raman spectra of the resulting CNT give clear evidence for the presence of SWNTs; that is, strong breathing mode bands (at 200-300 cm⁻¹), characteristic of SWNT), sharp G bands (1590 cm⁻¹) characteristic of ordered carbon in sp2 configuration, and low D bands (1350 cm⁻¹), characteristic of disordered carbon in sp3 configuration.

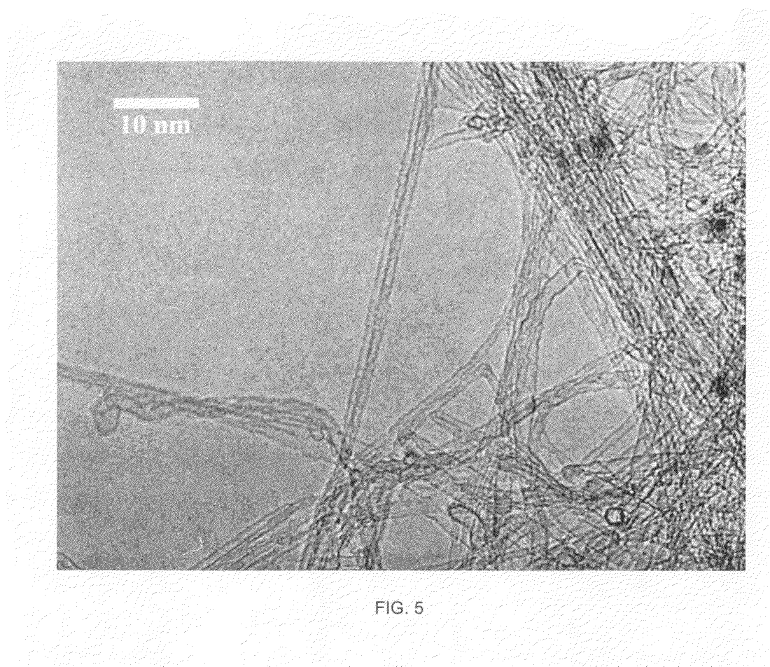

FIG. 5 is a TEM image of the resulting CNT produced with CO₂.

Alternatively, the catalytic precursor solution may be applied to the substrate movable support system via spin coating, dipping, spraying, screen printing, coating, or other methods known in the art. Also, the drying process can be done slowly, by letting the flat substrate rest at room temperature and covered to keep a higher relative humidity and lower air circulation than in open air.

The Fe—Mo/MgO catalyst thus produced can be further dried in an oven at 100° C. for 10 min, then calcined in air at 500° C. (or 400° C.-600° C. for 15 min in a muffle.

Alternatively, the reduction temperature can be varied between 550° C. to 950° C. and the reduction time from 1 to 30 min. The heating procedure can be either using a ramp from 1 to 100° C./min, or by introducing the sample on a preheated zone.

### EXAMPLE 2

### (A) Growth of MWNTs on Fe—Co/CaCO₃ Catalysts

Fe—Co/CaCO₃ catalysts. The stoichiometric composition of the catalyst was Fe:Co:CaCO₃=2.5:2.5:95 wt %. First, the weighted amount of metal salts Fe(NO₃)₃.9H₂O and Co(CH₃COO)₂.4H₂O were dissolved into distilled water with agitation, and CaCO₃ was added to the solution after the metal salts were completely dissolved. The pH-value of the mixture solution was adjusted to about 7.5 by dripping ammonia solution, in order to avoid the release of CO₂ occurring when carbonates contact acids. Then, the water was evaporated with a steam bath under continuous agitation, and the catalyst was further dried at about 130° C. overnight.

Carbon nanotubes were synthesized on the Fe—Co/CaCO₃ catalyst with cCVD approach using acetylene as carbon source. About 100 mg of the catalyst was uniformly spread into a thin layer on a graphite susceptor and placed in the center of a quartz tube with inner diameter of 1 inch, which is positioned horizontally inside a resistive tube furnace. Heating was applied after purging the system with nitrogen at 200 ml/min for 10 minutes, and acetylene was introduced at 4.3 ml/min for about 30 minutes when the temperature reached around 720° C. These flow rates correspond to a linear velocity of the gas mixture inside the reactor of 40 cm/min. Therefore it takes approximately 14 seconds for the acetylene/nitrogen mixture to travel from one side to the other one of the 9 cm long catalyst bed.

The as-produced CNTs were purified in one easy step using diluted hydrochloric acid solution and sonication.

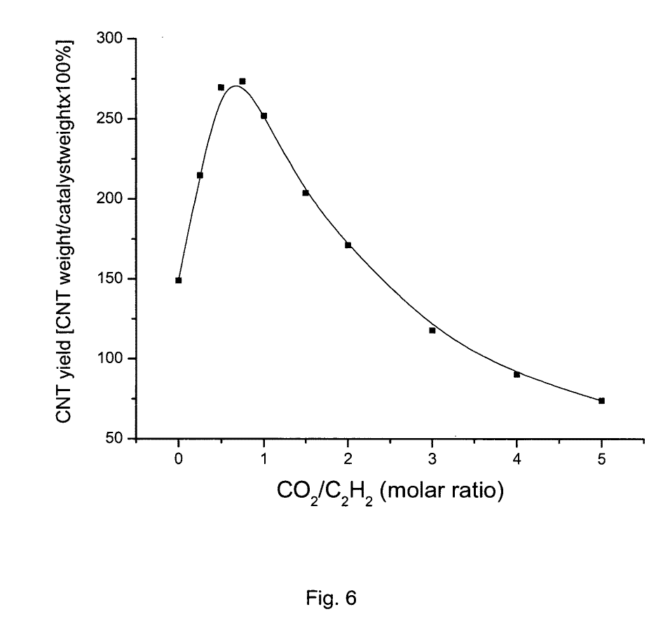

FIG. 6 shows the MWNTs yield as a function of CO₂/C₂H₂ ratio, indicating the effects of CO₂ on the morphology of MWNT. (B) Effects of Fe/Co concentration on MWNTs density on the catalytic flat substrate.

MWNTs were grown for 30 min under C₂H₂ (4.3 ml/min) at 750° C. over two surfaces having different loadings of Fe/Co catalytic metal.

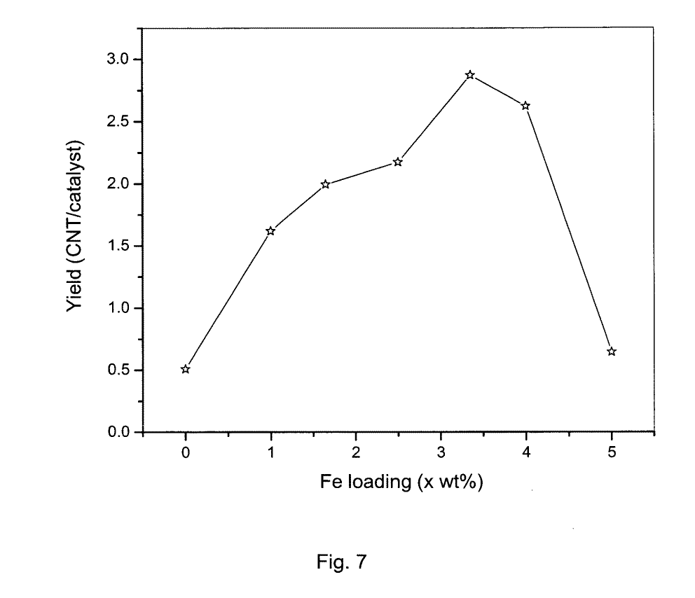

FIG. 7 shows the MWNT yield obtained from FeₓCO₅₋ₓ/CaCO₃ (Fe:Co:CaCO₃ weight ratio=x: 5-x: 95) catalysts. In FIG. 7, the Fe/Co metal loading on the CaCO₃ powder was 5 wt %.

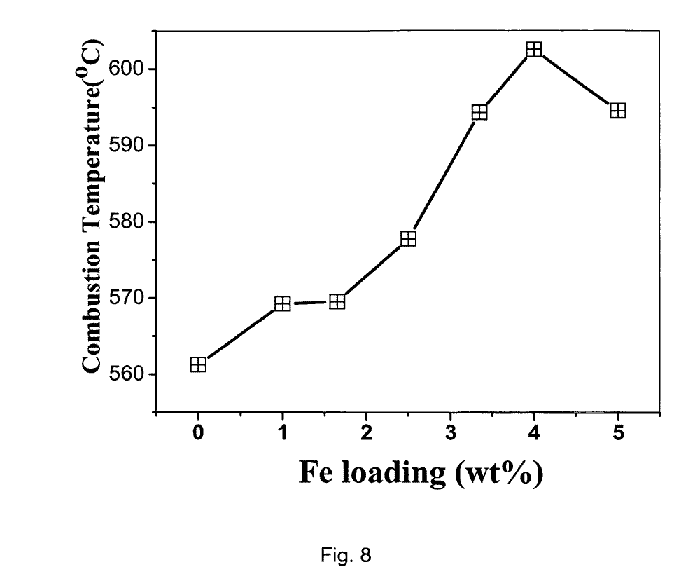

FIG. 8 shows the combustion temperature of MWNT as a function of Fe loading in the FeₓCo5-x/CaCO₃ (Fe:Co:CaCO₃ weight ratio=x: 5-x: 95) catalysts. In FIG. 8, the combustion temperature increases with the Fe loading, and reaches the maximum at Fe to Co atomic ratio 2:1. It also indicate the highest crystallinity.

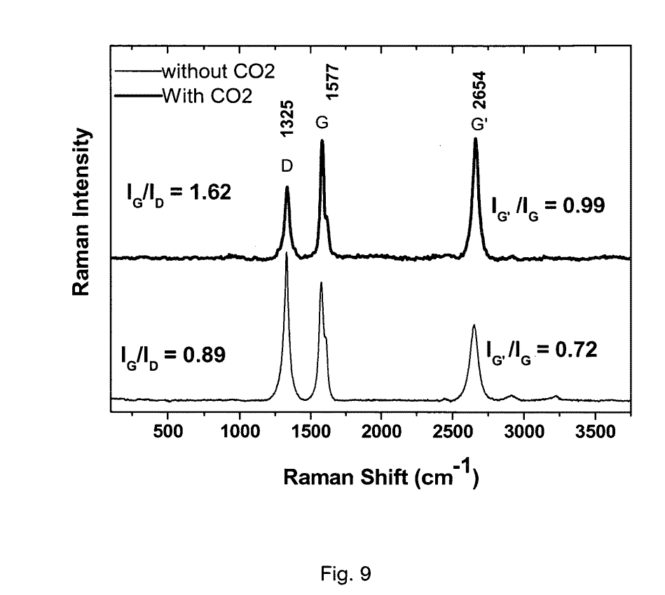

FIG. 9 shows the Raman scattering spectra from the MWNTs grown with and without CO₂. The higher I_{G}/I_{D} and I_{G}/I_{G} values of the MWNTs grown with CO₂ indicate higher quality. The Raman analysis clearly shows the presence of proper concentration of CO₂ in the carbon source can reduce the defects, as indicated by a sharp G band (1590 cm⁻¹) characteristic of ordered carbon, and a low D band (1350 cm⁻¹), characteristic of disordered carbon.

What is claimed is:

1. A method for producing carbon nanostructures from catalytic chemical vapor deposition, comprising exposing a catalyst to a mixture of gases comprising (a) a carbon-containing gas comprising at least one hydrocarbon and (b) carbon dioxide, said carbon-containing gas in sufficient concentrations and at a sufficient temperature to result in the deposition of carbon on the catalyst and resulting in the formation of carbon nanostructures thereon.

2. The method of claim 1, wherein said carbon nanostructures comprise single-walled carbon nanotubes, double-walled carbon nanotubes, multi-walled carbon nanotubes, nanofibers or a combination of any of them.

3. The method of claim 1, wherein said hydrocarbon is selected from the group consisting of (a) aliphatic hydrocarbons, both saturated and unsaturated, including methane, ethane, propane, butane, hexane, ethylene, and propylene and (b) aromatic hydrocarbons, including toluene, benzene and naphthalene.

4. The method of claim 1, wherein said mixture further comprises an oxygen-containing gas.

5. The method of claim 4, wherein said oxygen-containing gas is an alcohol.

6. The method of claim 5, wherein the molar ratio of said carbon dioxide to said hydrocarbon is from about 1:20 to about 1:1.

7. The method of claim 1, wherein said catalyst comprises a catalytic metal composition deposited upon a support material.

8. The method of claim 7, wherein said support material is a flat substrate.

9. The method of claim 7, wherein said support material is a powder.

10. The method of claim 7, wherein said metal composition comprises a metal from Group VIII, Group VIb, Group Vb or rhenium.

11. The method of claim 7, wherein said metal composition comprises rhenium and a metal from Group VIII.

12. The method of claim 11, wherein said metal composition further comprises a metal from Group VIb or Group Vb.

13. The method of claim 7, wherein said metal composition comprises a metal from Group VIII and a metal from Group VIb.

14. The method of claim 13, wherein the molar ratio of said Group VIII metal to said Group VIb metal is from about 1:10 to about 10:1.

15. The method of claim 14, wherein said molar ratio is from about 1:5 to about 5:1.

16. The method of claim 8, wherein said flat substrate is selected from the group consisting of wafers and sheets of SiO₂, Si, organometalic silica, p- or n-doped Si wafers with or without a SiO₂ layer, Si₃N₄, Al₂O₃, MgO, quartz, glass, oxidized silicon surfaces, silicon carbide, ZnO, GaAs, GaP, GaN, Ge, InP, sheets of metal including iron, steel, stainless steel or molybdenum and ceramics including alumina, magnesia and titania.

17. The method of claim 9, wherein said powder is an oxide powder selected from the group consisting of MgO, Al₂O₃, SiO, CaO, TiO, and ZrO.

18. The method of claim 1, wherein said catalyst is exposed to said mixture in a reactor selected from the group consisting of a packed bed reactor, a structured catalytic reactor, and a moving bed reactor.

19. The method of claim 7, where said metal composition is loaded on said support material at a loading of from 0.01 to 10 wt % of weight of the support material.

20. The method of claim 1, wherein said temperature is between about 600° C. and 1100° C.

21. The method of claim 20, wherein said temperature is between about 650° C. and 1000° C.

22. The method of claim 21, wherein said temperature is between 750° C. and 950° C.

23. The method of claim 1, wherein said carbon-containing gas is mixed with a carrier gas.

24. The method of claim 23, wherein said carrier gas is an inert gas.

25. The method of claim 24, wherein the molar ratio of the carbon-containing gas to the inert gas is from about 1:20 to about 1:2.
